(19) United States
(12) Patent Application Publication
(10) Pub. No.: US 2016/0373656 A1
(43) Pub. Date: Dec. 22, 2016

(54) IMAGING APPARATUS

(71) Applicant: Panasonic Intellectual Property Management Co., Ltd., Osaka (JP)

(72) Inventor: TAKAHIRO IKEDA, Osaka (JP)

(21) Appl. No.: 15/255,139

(22) Filed: Sep. 2, 2016

Related U.S. Application Data
(63) Continuation of application No. PCT/JP2015/001168, filed on Mar. 5, 2015.

(30) Foreign Application Priority Data
Mar. 28, 2014 (JP) 2014-068185

(51) Int. Cl. H04N 5/232; H04N 5/225

(52) U.S. Cl. CPC H04N 5/23293; H04N 5/2257; H04N 5/23245

(57) ABSTRACT

The imaging apparatus includes an imaging unit for generating image data by imaging an object, a recording unit for recording the image data, a display unit for displaying a live-view image that is a real-time moving image of the image data and an after-view image that is a still image to be recorded in the recording unit, and a controller. The controller makes the imaging unit perform a continuous imaging in a first cycle, and then makes the imaging unit perform another continuous imaging in a second cycle longer than the first cycle. The controller prompts the display unit to fall in a first display state while the imaging unit performs an image capturing in the first cycle, and the controller prompts the display unit to fall in a second display state different from the first display state while the imaging unit performs an image capturing in the second cycle.

### BACKGROUND

1. Technical Field

The present disclosure relates to driving a shutter of an imaging apparatus that is capable of continuous shooting.

2. Description of the Related Art

Patent literature 1 discloses a shutter mechanism that switches a normally-open drive mode to a normally-close drive mode and vice-versa by changing a rotating direction of a charge motor.

### CITATION LIST

Patent Literature 1: International Publication No. 2013/027420

### SUMMARY

The present disclosure aims to provide an imaging apparatus that can display a content appropriate to a reduction in a shooting speed during a series of continuous shooting.

The imaging apparatus of the present disclosure is formed of the following structural elements:
an imaging unit for generating image data by imaging an object;
a recording unit for recording the image data generated by the imaging section;
a display unit capable of displaying a live-view image that is a real-time moving image of the image data generated by the imaging unit and an after-view image that is a still image to be recorded in the recording unit ; and
a controller for controlling the imaging unit and the display unit.

The controller makes the imaging unit perform an image capturing action continuously in a first cycle, and then makes the imaging unit perform an image capturing action continuously in a second cycle longer than the first cycle. The controller prompts the display unit to fall in a first display state while the imaging unit performs the image capturing action in the first cycle, and the controller prompts the display unit to fall in a second display state different from the first display state while the imaging unit performs the image capturing action in the second cycle.

The present disclosure aims to provide an imaging apparatus that can display a content appropriate to a reduction in a shooting speed during a series of continuous shooting.

### BRIEF DESCRIPTION OF THE DRAWINGS

FIG. 1 shows an electrical structure of a digital camera in accordance with a first embodiment of the present disclosure.

FIG. 2A shows a structure of a mechanical shutter and a charge block in accordance with the first embodiment.

FIG. 2B shows a structure of the mechanical shutter in accordance with the first embodiment.

FIG. 3A is a schematic diagram illustrating the mechanical shutter in a normally-open drive mode in accordance with the first embodiment.

FIG. 3B is a schematic diagram illustrating the mechanical shutter in the normally-open drive mode in accordance with the first embodiment.

FIG. 3C is a schematic diagram illustrating the mechanical shutter in the normally-open drive mode in accordance with the first embodiment.

FIG. 3D is a schematic diagram illustrating the mechanical shutter in the normally-open drive mode in accordance with the first embodiment.

FIG. 4A is a schematic diagram illustrating the mechanical shutter in a normally-close drive mode in accordance with the first embodiment.

FIG. 4B is a schematic diagram illustrating the mechanical shutter in the normally-close drive mode in accordance with the first embodiment.

FIG. 4C is a schematic diagram illustrating the mechanical shutter in the normally-close drive mode in accordance with the first embodiment.

FIG. 4D is a schematic diagram illustrating the mechanical shutter in the normally-close drive mode in accordance with the first embodiment.

FIG. 5 is a time-chart of an image capturing action in the normally-open drive mode of a digital camera in accordance with the first embodiment.

FIG. 6 is a time-chart of an image capturing action in the normally-close drive mode of the digital camera in accordance with the first embodiment.

FIG. 7 is a flowchart of an operation of the digital camera in accordance with the first embodiment.

FIG. 8 is a schematic diagram illustrating a display performance of the digital camera in accordance with the first embodiment.

FIG. 9 is a flowchart of an operation of the digital camera in accordance with a second embodiment of the present disclosure.

FIG. 10 is a schematic diagram illustrating a display performance of the digital camera in accordance with the second embodiment.

FIG. 11 is a schematic diagram illustrating a storage amount of a buffer in accordance with a third embodiment of the present disclosure.

FIG. 12 is a flowchart of an operation of a digital camera in accordance with the third embodiment.

### DETAILED DESCRIPTION

Exemplary embodiments of the present disclosure are detailed hereinafter with reference to the accompanying drawings. Descriptions more than necessary are sometimes omitted, for instance, well-known matters will be not detailed, or substantially the same matters are not redundantly described for the ordinary skilled person in the art to simply understand the present disclosure.

The accompanied drawings and the descriptions below are provided for the ordinary skilled person in the art to fully understand the present disclosure, and these materials do not limit the scope of the claims or the subject of the present disclosure.

### 1. First Exemplary Embodiment

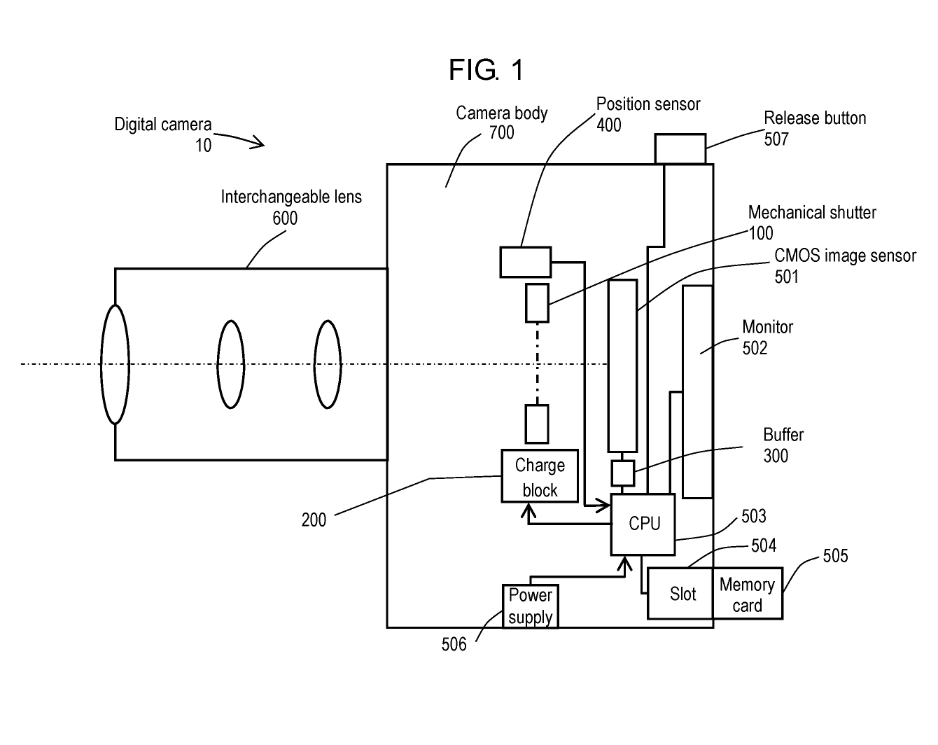

Digital camera 10 in accordance with the first embodiment is demonstrated hereinafter with reference to FIG. 1-FIG. 8. Digital camera 10 is an example of the imaging apparatus.

### 1-1. Structure

### 1-1-1. Structure of Digital Camera

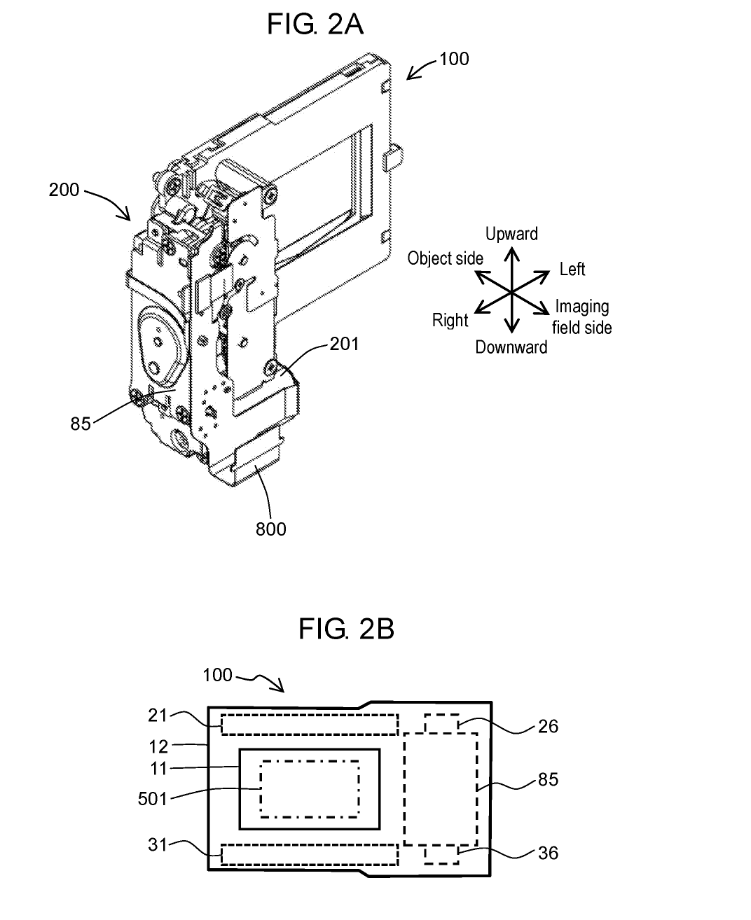

The structure of digital camera 10 is demonstrated hereinafter with reference to FIG. 1, FIG. 2A, and FIG. 2B.

FIG. 1 shows an essential part of the electrical structure of digital camera 10, which is formed of interchangeable lens 600 and camera body 700. Camera body 700 includes mechanical shutter 100, charge block 200, buffer 300, position sensor 400, CMOS image sensor 501, monitor 502, CPU 503, slot 504 into which memory card 505 is inserted, power supply 506, and release button 507.

Interchangeable lens 600 is detachable from camera body 700, and is formed of an optical system including a zoom lens, focus lens, shake correction lens, and iris. Interchangeable lens 600 also includes a driver for driving the optical system.

Buffer 300 functions as a work-memory for an image processor (not shown) or CPU 503. For instance, buffer 300 temporarily stores image date shot by CMOS image sensor 501, and is formed of, for instance, DRAM or ferroelectric memory. Buffer 300 is an instance of the recording unit.

Position sensor 400 is disposed at a place where position sensor 400 can detect that a front curtain or a rear curtain of the mechanical shutter moves to a given position, and is formed of, for instance, photo-interrupter.

CMOS image sensor 501 is an example of an imaging element, and generates image data from an optical image, formed by interchangeable lens 600, of an object by photoelectric conversion. CMOS image sensor 501 obtains still image date and moving image data. The obtained moving image data can be used for displaying a live-view (LV) image.

Monitor 502 displays the image data obtained from CMOS image sensor 501, and can display an imaging condition and an operation menu of digital camera 10 together in addition to the image data. Monitor 502 is formed of, for instance, a liquid crystal display.

CPU 503 controls digital camera 10 entirely, and includes an inner memory that records information necessary for shooting. CPU 503 can be formed of a hard-wired electronic circuit or a microprocessor.

Memory card 505 is detachable from slot 504. Slot 504 controls memory card 505 based on a control signal transmitted from CPU 503. To be more specific, slot 504 allows memory card 505 to store image data, and allows memory card 505 to output the image data.

Power supply 506 supplies electric power necessary for operating entire digital camera 10, and can be formed of a dry cell or a rechargeable battery, or power supply 506 can feed the electric power supplied externally via a power cord to digital camera 10.

Release button 507 forms a two-stage operating button. A half-push onto release button 507 by a user prompts CPU 503 to perform a focusing process at a given position of an image. A full-push onto release button 507 by the user prompts CPU 503 to drive mechanical shutter 100 for controlling light-exposure to CMOS image sensor 501. Then CPU 503 stores image data in memory card 505. When digital camera 10 is set in a continuous shooting mode, digital camera 10 keeps recording the image data at given time intervals during the full-push onto release button 507 by the user.

### 1-1-2. Structure of Shutter Section

FIG. 2A illustrates the structures of mechanical shutter 100 and charge block 200. FIG. 2B schematically shows mechanical shutter 100 viewed from an object side.

Mechanical shutter 100 is an ordinary focal-plane shutter including front curtain 31 and rear curtain 21 in addition to a base member having opening 11.

Opening 11 of mechanical shutter 100 is a hole through which light travels. Viewed from the object side, mechanical shutter 100 includes CMOS image sensor 501 disposed ahead opening 11.

Rear curtain 21 is disposed movably in a vertical direction within mechanical shutter 100. Rear curtain 21 is supported movably in a vertical direction by shutter-driving mechanism 85. Front curtain 31 is disposed movably in the vertical direction within mechanical shutter 100. Front curtain 31 is supported movably in the vertical direction by shutter-driving mechanism 85. In this first embodiment, rear curtain 21 retracts above opening 11, and front curtain 31 retracts below opening 11; however, rear curtain 21 and front curtain 31 can be disposed oppositely to what is discussed above.

Electromagnet 26 for rear curtain is an electromagnet, and falls in a current-carrying state or in a noncurrent-carrying state. Electromagnet 26 for rear curtain falls in the current carrying state when it adsorbs an end of rear curtain 21, and the end of rear curtain 21 is not adsorbed by electromagnet 26 for rear curtain staying in the noncurrent carrying state. Electromagnet 26 for rear curtain switches the current carrying state to the noncurrent carrying state, thereby controlling a retaining state of rear curtain 21.

Electromagnet 36 for front curtain is an electromagnet, and falls in a current-carrying state or in a noncurrent-carrying state. Electromagnet 36 for front curtain falls in the current carrying state when it adsorbs an end of front curtain 31, and the end of front curtain 31 is not adsorbed by electromagnet 36 for front curtain staying in the noncurrent carrying state. Electromagnet 36 for front curtain switches the current carrying state to the noncurrent carrying state, thereby controlling a retaining state of front curtain 31. Charge block 200 includes shutter-driving mechanism 85, charge motor 201, and flexible cable 800.

Shutter-driving mechanism 85 supports rear curtain 21 and front curtain 31 in a movable manner with respect to mechanical shutter 100, and includes a front-curtain running spring, front-curtain setting spring, rear-curtain running spring, rear-curtain setting spring, and drive lever. These springs and the drive lever are not shown in the drawings. The front-curtain running spring applies elastic force to rear curtain 21 for running rear curtain 21 upward. The front-curtain setting spring applies elastic force to rear curtain 21 for running rear curtain 21 downward. The elastic force of the front-curtain running spring is greater than that of the front-curtain setting spring, so that rear curtain 21 can run upward acting counter to the elastic force of the front-curtain setting spring. The rear-curtain running spring applies energizing force to front curtain 31 for running front curtain 31 upward. The drive lever is rotatably supported with respect to charge block 200. Drive of the drive lever will compress the front-curtain running spring and the rear-curtain running spring, thereby charging the elastic force to be used for running rear curtain 21 and front curtain 31. This charging action can be done by winding charge motor 201.

Charge motor 201 applies driving force to shutter-driving mechanism 85. A gear (not shown) in charge motor 201 engages with another gear (not shown) disposed in shutter-driving mechanism 85. Winding the charge motor 201 will prompt shutter-driving mechanism 85 to start the charging action. Charge motor 201 is, for instance, formed of a DC motor, and is controlled by CPU 503.

Flexible cable 800 includes a circuit pattern, and is connected to CPU 503 and position sensor 400. Flexible cable 800 is formed of, for instance, a flexible printed circuit card (FPC) excellent in flexibility.

Interchangeable lens 600 and CMOS image sensor 501 are examples of the imaging unit. Monitor 502 is an example of the display unit. CPU 503 is an example of the controller. Mechanical shutter 100 is an example of a shutter mechanism.

### 1-2. Operation

Digital camera 10 in accordance with the first embodiment switches the rotating direction of charge motor 201, thereby switching a normally-open image capturing action to a normally-closed image capturing action and vice versa. To be more specific, forward rotation of charge motor 201 prompts shutter-driving mechanism 85 to drive front curtain 31 and rear curtain 21 for performing the normally-open image capturing action. Backward rotation of charge motor 201 prompts shutter-driving mechanism 85 to drive front curtain 31 and rear curtain 21 for performing the normally-close shooting action.

The normally-open image capturing action is one of image capturing actions, and this action retracts front curtain 31 and rear curtain 21 from opening 11 during a preparation action for imaging in the continuous shooting mode. The normally-close image capturing action is one of image capturing actions, and this action prevents front curtain 31 and rear curtain 21 from retracting from opening 11 during the preparation action for imaging in the continuous shooting mode. These two actions are more detailed below.

1-2-1. Normally-open image capturing action

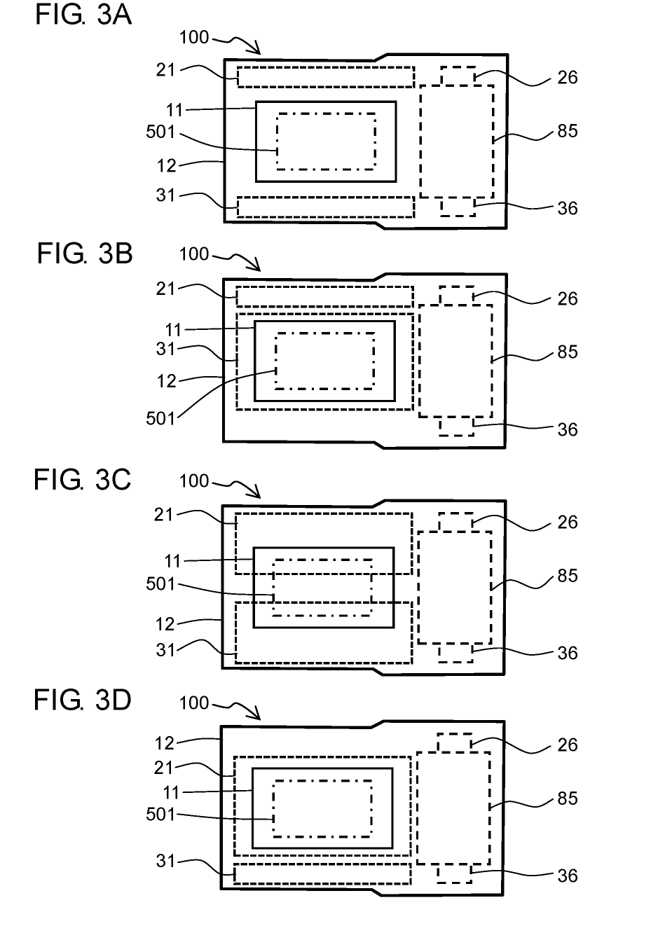

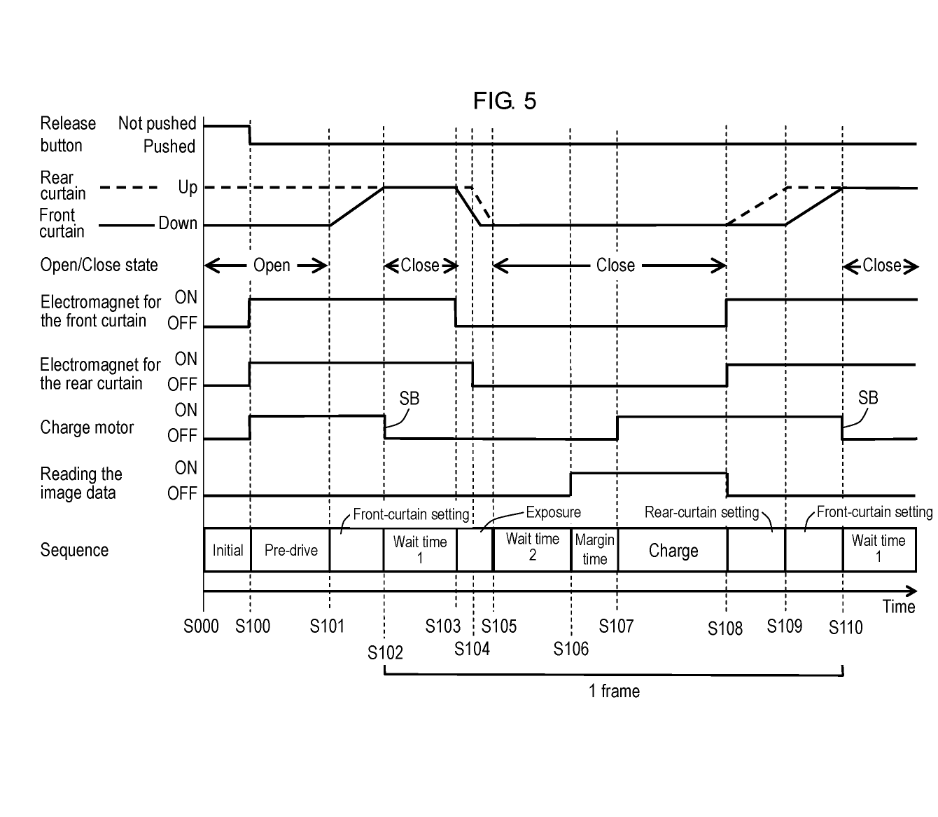

The normally-open image capturing action is demonstrated hereinafter with reference to FIG. 3A-FIG. 3D, and FIG. 5. FIG. 3A-FIG. 3D illustrate mechanical shutter 100 driven during the normally-open image capturing action. FIG. 5 is an operational time-chart of digital camera 10 during the normally-open image capturing action.

Actions of mechanical shutter 100 when digital camera 10 performs shooting operation are demonstrated with reference to FIG. 3A-FIG. 3D. When digital camera 10 stays in the shooting mode, both of rear curtain 21 and front curtain 31 stay retracting from opening 11 (FIG. 3A) until a user presses the release button. In this case, mechanical shutter 100 falls in the state shown in FIG. 3A, and the light entering from opening 11 forms an image in CMOS image sensor 501.

When the user full-pushes (turn-on) release button 507, front curtain 31 covers opening 11 (FIG. 3B), so that digital camera 10 falls into a state in which the light does not reach CMOS image sensor 501. When a mechanical action of covering opening 11 by front curtain 31 becomes stable, then front curtain 31 and rear curtain 21 run, such that rear curtain 21 follows after front curtain 31 with a slit as shown in FIG. 3C. When an exposure time is set longer than a given time, rear curtain 21 starts running in a given time after front curtain 31 ends the running. CMOS image sensor 501 takes an object image from the slit between front curtain 31 and rear curtain 21.

When the running action ends, rear curtain 21 is retained such that it covers opening 11 (FIG. 3D), whereby digital camera 10 falls into the state in which the light does not reach CMOS image sensor 501. At this time, CPU 503 takes the image data from CMOS image sensor 501. After the take-out of the image data, digital camera 10 moves again to a state in which digital camera 10 can shoot. When digital camera 10 is set in the continuous shooting mode, the foregoing actions are repeated while the user keeps pushing release button 507.

As discussed above, during the normally-open image capturing action, front curtain 31 and rear curtain 21 stay retracting from opening 11 as shown in FIG. 3A every time the continuous shooting is done.

The time chart of the normally-open image capturing action is described with reference to FIG. 5. When digital camera 10 is set in the continuous shooting mode, mechanical shutter 100 stays open for waiting a push onto release button 507 by a user. At this time digital camera 10 displays an LV image obtained from CMOS image sensor 501 on monitor 502 (time S000).

A push onto release button 507 by the user prompts electromagnet 36 for front curtain and electromagnet 26 for rear curtain to be turned on (time S100). Charge motor 201 is also turned on at time S100.

Then charge motor 201 starts charging the shutter-driving mechanism (pre-drive). Completion of the charging (time S101) prompts shutter-driving mechanism 85 to drive front curtain 31 for setting front curtain 31 in a state shown in FIG. 3B (front-curtain setting).

Completion of the front-curtain setting (time S102) prompts charge motor 201 to perform short-brake (SB). At the setting of front curtain 31, since front curtain 31 is driven by shutter-driving mechanism 85 including the springs, front curtain 31 remains in small oscillation after the completion of the front-curtain setting. This small oscillation possibly affects the next action, so that a stabilization wait time for a given time is needed until front curtain 31 becomes stable (wait time 1) after front curtain 31 has been set. The given time refers to a time long enough for the small oscillation to attenuate, and this given time has been pre-set in digital camera 10.

When front curtain 31 falls in a stable state, CPU 503 turns off the power to electromagnet 36 for front curtain (time S103). This turn-off allows front curtain 31 to be released from the adsorption, so that front curtain 31 is retracted from opening 11 by shutter-driving mechanism 85.

After a lapse of a given time (shutter speed), CPU 503 turns off the power to electromagnet 26 for rear curtain (time S104). The turn-off allows rear curtain 21 to be released from the adsorption, so that rear curtain 21 closes opening 11 by shutter-driving mechanism 85 (time S105).

During the time from time S103 to time S105, opening 11 in part is not covered (exposure) with front curtain 31 or rear curtain 21 as shown in FIG. 3C. The light through this non-covered part reaches CMOS image sensor 501. In this embodiment, the time from time S103 to time S105 is referred to as an exposure time, which indicates the time when front curtain 31 starts running until when rear curtain 21 ends running The exposure time is determined by a shutter speed set by a user and running speeds of front curtain 31, rear curtain 21. Meanwhile, the shutter speed refers to, in general, a time when front curtain 31 starts running until when rear curtain 21 starts running (time S103-time S104).

When front curtain 31 completely retracts from opening 11 and rear curtain 21 completely closes opening 11 (time S105), opening 11 is blocked by rear curtain 21 as shown in FIG. 3D. In this state, the light entering CMOS image sensor 501 is blocked by rear curtain 21. During the exposure from time S103 to time S105, both of front curtain 31 and rear curtain 21 are driven by shutter-driving mechanism 85 including the springs, so that front curtain 31 and rear curtain 21 remain in small oscillation after the exposure ends. Since this small oscillation possibly affects actions thereafter, a stabilization wait time for a given time is needed until front curtain 31 and rear curtain 21 become stable (wait time 2). This given time is a time long enough for front curtain 31 and rear curtain 21 to become stable, and has been pre-set in digital camera 10.

When front curtain 31 and rear curtain 21 fall in a stable state, CPU 503 reads (ON) the image data from CMOS image sensor 501 (time S106). In parallel to the read-out of the image data, shutter-driving mechanism 85 is charged (ON) by charge motor 201 after a lapse of a given time (margin time) to prepare for imaging a next frame (time S107). The margin time from time S106 to time S107 is detailed later. The time needed for the charge is determined by a mechanical factor when charge motor 201 charges shutter-driving mechanism 85.

CPU 503 supplies power to electromagnet 36 for front curtain and electromagnet 26 for rear curtain simultaneously with the charging action. Shutter-driving mechanism 85 retracts rear curtain 21 from opening 11 (time S108), which is then adsorbed by electromagnet 26 for rear curtain. Shutter-driving mechanism 85 then starts setting front curtain 31 such that front curtain 31 covers opening 11 (time S109). Completion of setting front curtain 31 (time S110) prompts electromagnet 36 for front curtain to adsorb front curtain 31. After the settings of front curtain 31 and rear curtain 21, a short-brake is applied to charge motor 201 to wait for front curtain 31 and rear curtain 21 to become stable. In other words, time S110 corresponds to time S102. The action of setting rear curtain 21 (time S108-time S109) is actually done simultaneously with the charging action.

The margin time (time S106-time S107) is detailed hereinafter. As discussed above, the charge time is determined by the mechanical factor, and a sequence of mechanical shutter 100 is performed regardless of reading the image data. To be more specific, mechanical shutter 100 starts setting rear curtain 21 upon the end of the charge regardless of the completion of reading the image data. In this case, if the charge ends and the rear-curtain setting starts before the completion of reading the image data, CMOS image sensor 501 detects the light during the read of the image data. Then the image data that is currently read is possibly disturbed.

The margin time is set in order to prevent the foregoing situation. A time needed to read the image data is determined by a format of the image data, so that CPU 503 determines the margin time such that the image data can be read during a total time of the margin time and the charge time (time S106-time S108).

As discussed above, the normally-open image capturing action practices to retract front curtain 31 and rear curtain 21 from opening 11 between each frame during the continuous shooting (time S109). After front curtain 31 and rear curtain 21 retract from opening 11, front curtain 31 is set before the next frame is imaged.

### 1-2-2. Normally-Close Image Capturing Action

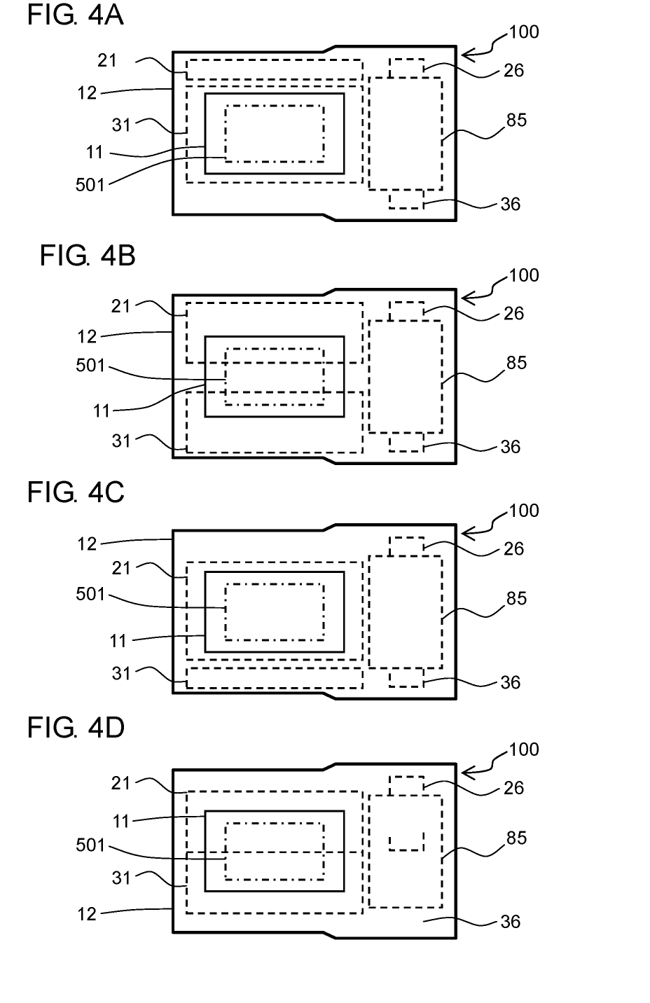

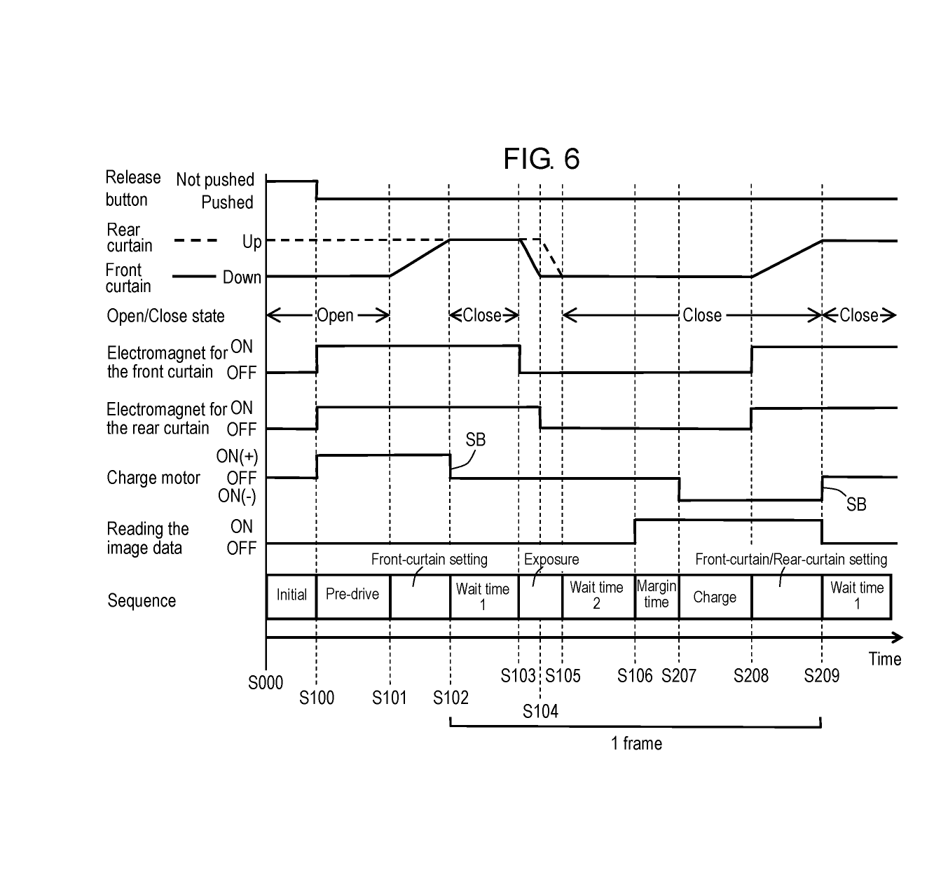

The normally-close image capturing action is described hereinafter with reference to FIG. 4A-FIG. 4D, and FIG. 6. FIG. 4A-FIG. 4D show mechanical shutter 100 driven during the normally-close image capturing action, and FIG. 6 is an operational time-chart of digital camera 10 during the normally-close image capturing action.

The actions of mechanical shutter 100 during the shooting operation of digital camera 10 is demonstrated with reference to FIG. 4A-FIG. 4D. FIG. 4A-FIG. 4C correspond to FIG. 3B-FIG. 3D respectively. During the normally-close image capturing action, when the exposure action ends as shown in FIG. 4C and the next image capturing action starts, the retraction of rear curtain 21 from opening 11 and the setting of front curtain 31 are simultaneously done as shown in FIG. 4D. Then front curtain 31 covers opening 11 as shown in FIG. 4A, and the imaging of the next frame starts. The foregoing process allows front curtain 31 and rear curtain 21 not to retract from opening 11 between each frame during the continuous shooting.

The imaging time-chart of the normally-close image capturing action is described with reference to FIG. 6. The same actions as those shown in FIG. 5 are denoted by the same reference marks and the descriptions thereof are omitted here.

A push of release button 507 by the user (time S100) prompts charge motor 201 to rotate forward (ON +) for starting pre-drive (time S100-time S101), then a first frame is shot (time S103-time S105). Read of the image data shot starts (time S106), and after a lapse of a given time therefrom, a charge action starts (time S207). At this time, an electric current reversal to that at time S100 flows to charge motor 201, so that charge motor 201 rotates backward (ON −), and mechanical shutter 100 is ready to perform the normally-close image capturing action.

During the normally-close image capturing action, front curtain 31 and rear curtain 21 are set as they keep covering opening 11 (FIG. 4D), so that digital camera 10 can read the image data, and front-curtain/rear-curtain setting is performed simultaneously. As a result, the normally-close image capturing action allows shortening the margin time Digital camera 10 starts setting (time S208) front curtain 31 and rear curtain 21 before the read action of the image data is completed (time S209). Then digital camera 10 waits for the curtains to become stable as same as in the normally-open image capturing action, and moves to an image capturing action of the next frame. Time S209 in the normally-close image capturing action corresponds to time S102 in the normally-open image capturing action.

### 1-2-3. Display Switching Action During Continuous Shooting

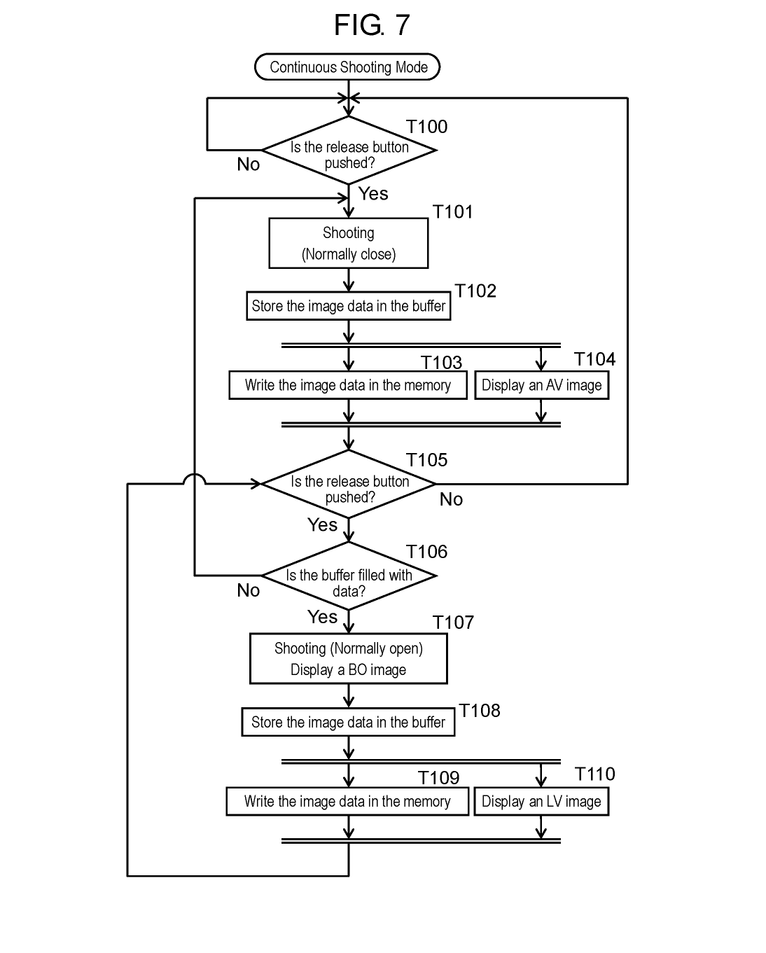

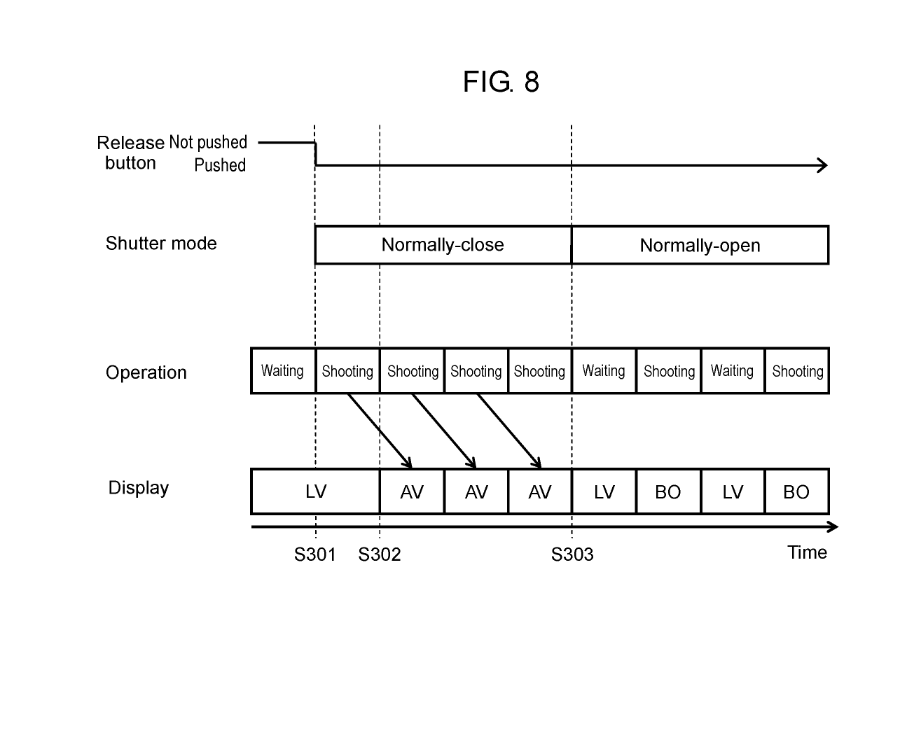

A display switching action during the continuous shooting is demonstrated with reference to FIG. 7 and FIG. 8. FIG. 7 is a flowchart of the display switching action, and FIG. 8 shows schematically the display switching action.

First, the display switching action during the continuous shooting is outlined with reference to FIG. 8. When the user gives an instruction of high-speed continuous shooting to digital camera 10 in accordance with the embodiment, digital camera 10 selects the continuous shooting operated in the normally-close drive mode that allows shortening a shooting time.

A push of release button 507 by the user (time S301) prompts digital camera 10 to start shooting. Every time one frame of the continuous shooting is shot, an after-view (AV) image is displayed on monitor 502 after this shooting action. The image data shot during the continuous shooting is temporarily stored in buffer 300, and then stored in memory card 505. The image data stored in memory card 505 is deleted from buffer 300. It takes a longer time to store the image data in memory card 505 than in buffer 300, so that when certain numbers of frames are shot, a data capacity of buffer 300 is fully occupied because memory card 505 cannot keep up the storing of the image data. The full of the data capacity of buffer 300 refers to not only a state where no remaining capacity is available at all but also a state where no capacity is available for storing one frame image data.

When the data capacity of buffer 300 becomes full, there is no vacant capacity for storing image data obtained by the imaging, so that digital camera 10 cannot image further more. In this case, it is necessary for finding a vacant capacity in buffer 300 after the image data is stored in memory card 505 in order to image the next frame. For this purpose, digital camera 10 should refrain from the image capturing action until the vacant capacity is found in buffer 300. As a result, a frame speed of the continuous shooting lowers. In the following description, the refrainment from the image capturing action for lowering the frame speed is referred to as applying the brakes to the continuous shooting.

As discussed above, when the frame speed in the continuous shooting lowers due to buffer 300 filled with data, it is not needed to use the normally-close image capturing action. On top of that, a lower frame speed of the continuous shooting causes longer intervals between each of AV images displayed on monitor 502, so that capturing an object becomes difficult. The lower frame speed thus incurs inconvenience to the user. To overcome this problem, when buffer 300 is filled with data, digital camera 10 in accordance with this embodiment switches the image capturing action from the normally-close drive mode to the normally-open drive mode. Switching to the normally-open drive mode prompts mechanical shutter 100 to retract front curtain 31 and rear curtain 21 from opening 11 at between each frame during the continuous shooting, whereby the LV image can be displayed.

In FIG. 8, assume that buffer 300 is filled with data at time S303, then digital camera 10 switches the image capturing action to the normally-open drive mode. Since buffer 300 is full, digital camera 10 should be on waiting until the vacant capacity is found in buffer 300 before starting the image capturing action. During the image capturing action, since the LV image cannot be displayed, monitor 502 displays a blackout (BO) image, and displays the LV image in the next waiting state. The mechanism discussed above allows digital camera 10 in accordance with this embodiment to prevent a time difference between an actual object and an image displayed on monitor 502 even if the frame speed of the continuous shooting lowers.

A display switching action during the continuous shooting is more detailed with reference to FIG. 7. When digital camera 10 is set in the continuous shooting mode, it monitors whether or not a user pushes release button 507 (step T100). A push of release button 507 (branch Yes of step T100) prompts digital camera 10 to start the normally-close image capturing action (step T101). The image data shot is temporarily stored in buffer 300 (step T102), then CPU 503 starts writing the image data into memory card 505 (step T103). Simultaneously with the writing, CPU 503 displays the image data stored in buffer 300 on monitor 502 as an AV image (step T104). Then digital camera 10 monitors whether or not release button 507 is kept being pushed (step T105). If the push is removed from release button 507 (branch No of step T105), digital camera 10 waits for a next shooting instruction from the user.

When release button 507 is kept being pushed (branch Yes of step T105), CPU 503 monitors whether or not buffer 300 is filled with data (step T106). If buffer 300 is not full (branch No of step T106), CPU 503 performs again the normally-close image capturing action (step T101). If buffer 300 is full (branch Yes of step T106), digital camera 10 performs normally-open image capturing action (step T107). At this time, monitor 502 displays the BO image, and digital camera 10 is on waiting until a sufficient vacant capacity is found in buffer 300. The image data shot is temporarily stored in buffer 300 (step T108), then is written into memory card 505 (step T109) as is done in the normally-close image capturing action. Simultaneously with the writing, CPU 503 displays the LV image, which is produced based on the image data generated by CMOS image sensor 501, on monitor 502 (step T110).

### 1-3. Advantage

As discussed previously, digital camera 10 in accordance with this embodiment can perform the normally-close image capturing action for high-speed continuous shooting while buffer 300 keeps a sufficient vacant capacity. When buffer 300 becomes full, digital camera 10 performs the normally-open image capturing action for low-speed continuous shooting and displays the LV image switchable to the BO image. If a frame speed in continuous shooting lowers, this structure allows preventing a time difference between an actual object and an image thereof displayed on monitor 502. In other words, the user can pursue the object even if a speed of the continuous shooting lowers.

### 2. Second Exemplary Embodiment

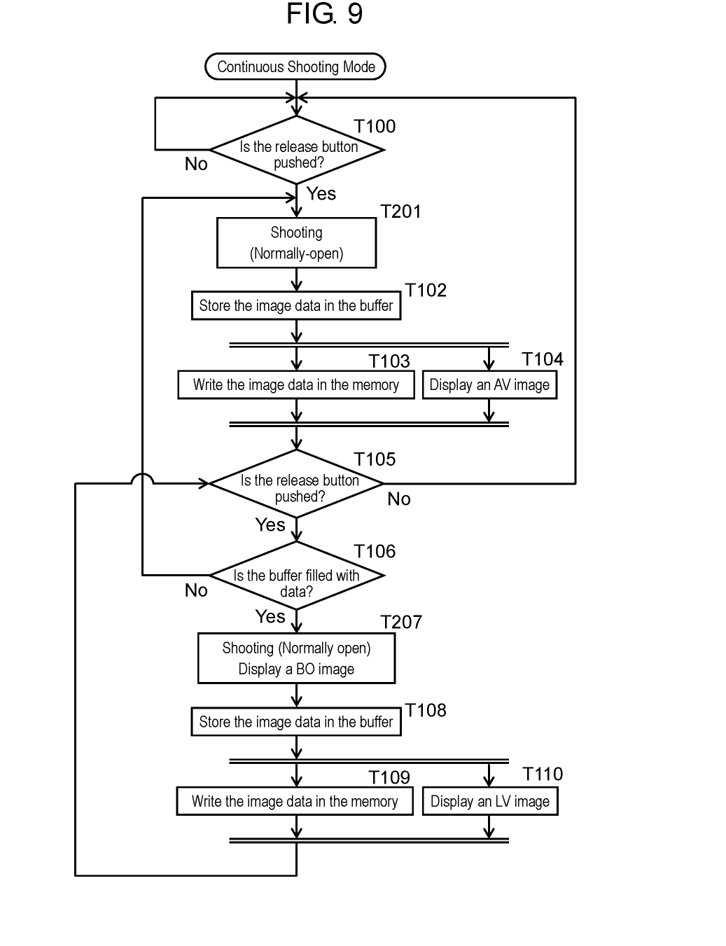

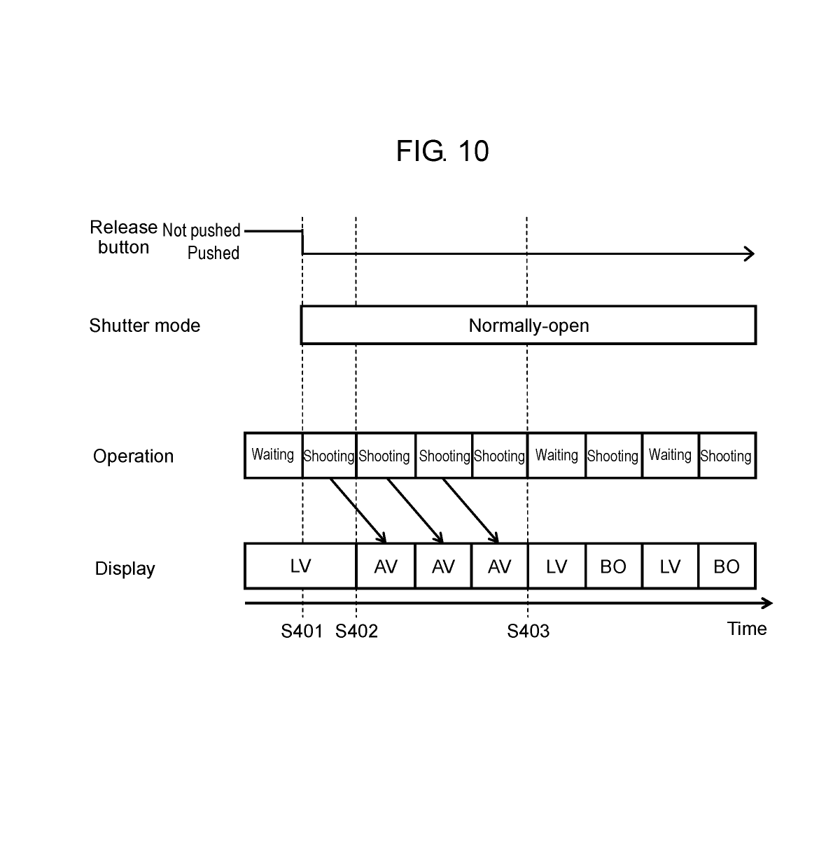

The second embodiment of the present disclosure is demonstrated hereinafter with reference to FIG. 9 and FIG. 10. Structural elements similar to those used in the first embodiment have the same reference marks, and duplicated descriptions are omitted here.

Digital camera 10 in accordance with the second embodiment performs the normally-open image capturing action although buffer 300 has a sufficient vacant capacity and a high-speed continuous shooting is carried out. This mechanism is detailed hereinafter.

### 2-1. Operation

FIG. 9 is a flowchart of continuous shooting done by digital camera 10 in accordance with the second embodiment. FIG. 10 outlines a display switching action during the continuous shooting action done by digital camera 10 in accordance with the second embodiment.

First, the display switching action is outlined with reference to FIG. 10. Different from the first embodiment, digital camera 10 performs the normally-open image capturing action although buffer 300 has a sufficient vacant capacity as is available at a start of the shooting. At this time, mechanical shutter 100 retracts front curtain 31 and rear curtain 21 from opening 11 during the continuous shooting as shown in FIG. 3A. Digital camera 10 thus can display the LV image on monitor 502.

However, when the continuous shooting is done at a very high speed, if the LV image is displayed on monitor 502 every time each frame is shot, the user possibly cannot fully recognize the LV image, because an LV image-displayable state indicated in FIG. 3A is available only for a very short time during the high-speed continuous shooting.

To overcome the foregoing problem, digital camera 10 in accordance with this second embodiment displays an AV image on monitor 502 (time S402-time S403 in FIG. 10) until buffer 300 is filled with data although it is driven in the normally-open mode. When buffer 300 becomes full at time S403, digital camera 10 prepares waiting actions for displaying an LV image and a BO image similar to what is done in the first embodiment. These waiting actions are done by digital camera 10 in the state where front curtain 31 and rear curtain 21 are retracted from opening 11 as shown in FIG. 3A.

As the flowchart in FIG. 9 shows, during the continuous shooting by digital camera 10 in accordance with this second embodiment, both the image capturing action (step T201) in the case of buffer 300 having a sufficient vacant capacity and the image capturing action (step T207) in the case of buffer 300 having an insufficient vacant capacity are done in the normally-open drive mode. Since the steps other than T201 and T207 are similar to what are shown in the flowchart in FIG. 7, the descriptions thereof are omitted here.

### 2-2. Advantage

As discussed previously, digital camera 10 in accordance with the second embodiment performs the normally-open image capturing action for a high-speed continuous shooting while buffer 300 has a sufficient vacant capacity, and displays the AV image on monitor 502. When buffer 300 becomes full, digital camera 10 performs the normally-open image capturing action for a low-speed continuous shooting, and displays the LV image switchable to the BO image on monitor 502. This mechanism allows displaying the LV image in the wait time when a frame speed of the continuous shooting lowers, so that the user can properly pursue the object.

### 3. Third Exemplary Embodiment

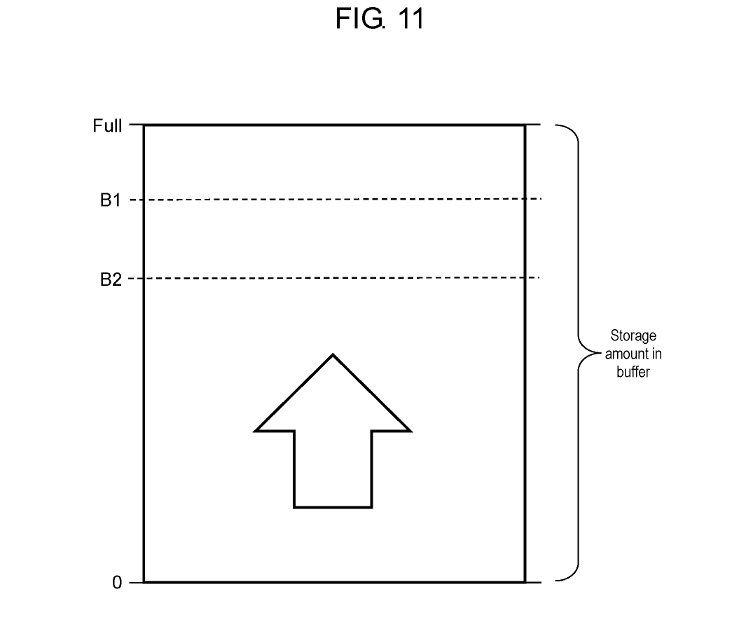

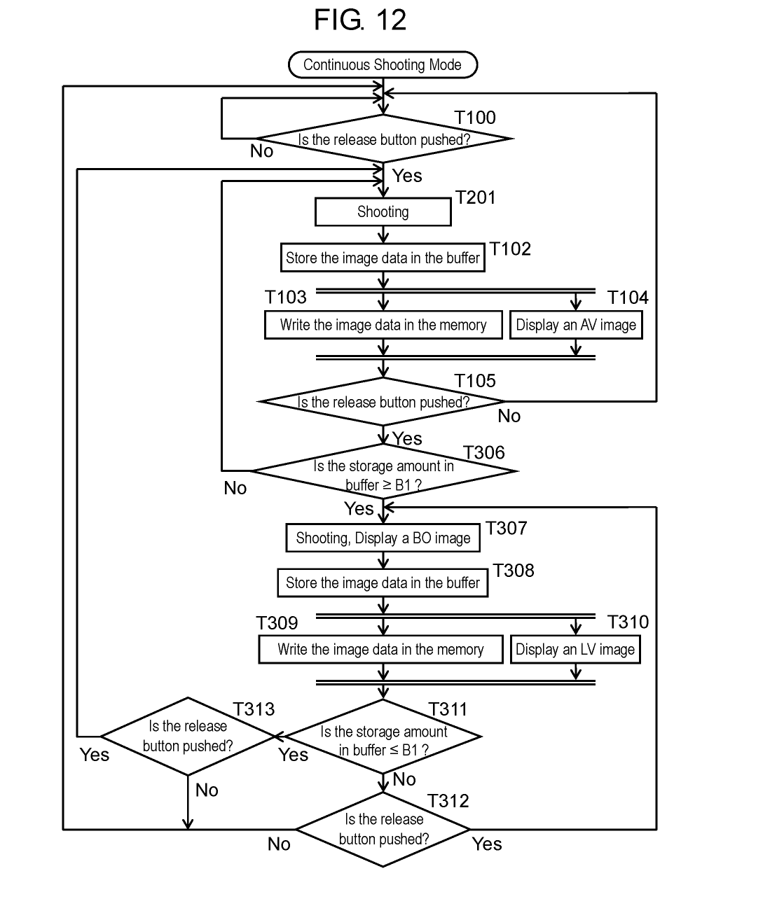

The third embodiment is demonstrated hereinafter with reference to FIG. 11 and FIG. 12. Structural elements similar to those used in the first and second embodiments have the same reference numbers, and the descriptions thereof are omitted here.

### 3-1. Operation

FIG. 11 shows schematically a vacant capacity of buffer 300. Digital camera 10 in accordance with the third embodiment carries out a display switching action during the continuous shooting in response to the vacant capacity of buffer 300.

The image data successively obtained by the continuous shooting is stored in buffer 300 each time. A directory in buffer 300 for storing the image data is vacant before the image data obtained by shooting the first frame is stored therein. In other words, the buffer shown in FIG. 11 stores nothing (zero).

The start of continuous shooting prompts buffer 300 to store the image data successively, and the image data temporarily stored in buffer 300 is then stored in memory card 505 step-by-step. However, since it takes a longer time to store the image data in memory card 505 than to store the image data in buffer 300, the stored amount in buffer 300 sometimes increases step-by-step.

When the stored amount in buffer 300 exceeds given threshold B1, digital camera 10 in accordance with this third embodiment applies the brakes to the continuous shooting for lowering the frame speed, and switches an image to be displayed on monitor 502. An actual switching action is detailed later.

If the continuous shooting is kept going with the frame speed being lowered by applying the brakes to the continuous shooting, an amount of data to be stored in buffer 300 sometimes decreases step-by-step. This phenomenon can be achieved by applying the brakes to the continuous shooting for longer time than the time necessary for storing the data in memory card 505.

When the stored amount in buffer 300 becomes smaller than given threshold B2, digital camera 10 in accordance with the third embodiment removes the brakes from the continuous shooting, and switches the image to be displayed on monitor 502 again. An actual switching action is detailed later.

As FIG. 11 shows, threshold B1 is preferably greater than threshold B2. If threshold B2 is greater than threshold B1, the stored amount in buffer 300 becomes smaller than threshold B2. This situation causes the problem below: After the brakes are removed from the shooing action, a determination of applying the brakes again requires the stored amount in buffer 300 be less than threshold B1. Then the stored amount in buffer 300 does not become smaller than threshold B1 but becomes full, so that the shooting possibly cannot be kept going.

The display switching action during the continuous shooting of digital camera 10 in accordance with the third embodiment is detailed with reference to FIG. 12, in which steps up to step T105 are the same as those in FIG. 9, so that the descriptions thereof are omitted here.

Receiving a pushing action onto release button 507, CPU 503 detects whether or not the stored amount in buffer 300 is greater than threshold B1 (step T306). When the stored amount in buffer 300 is smaller than threshold B1 (branch No of step T306), CPU 503 returns to step T201 for continuing the shooting action.

When the stored amount in buffer 300 is equal to or greater than threshold B1 (branch Yes of step T306), CPU 503 images the next frame and displays the BO image on monitor 502 (step T307). In this case, digital camera 10 is on waiting until a sufficient vacant capacity is found in buffer 300. The image data shot is temporarily stored in buffer 300 (step T308). Then the image data is written into memory card 505 (step T309), and simultaneously with the writing, CPU 503 displays the LV image based on the image data, generated by CMOS image sensor 501, on monitor 502 (step T310).

Completing the writing action into memory card 505, CPU 503 detects whether or not the stored amount in buffer 300 is equal to or smaller than threshold B2 (step T311). When the stored amount in buffer 300 is greater than threshold B2 (branch No of step T311), CPU 503 detects whether or not release button 507 is pushed (step T312). When release button 507 is pushed (branch Yes of step T312), CPU 503 carries out the action shown in step T307. When release button 507 is not pushed (branch No of step T312), CPU 503 returns to step T100, and waits for an instruction for the next shooting.

When the stored amount in buffer 300 is equal to or smaller than threshold B2 (branch Yes of step T311), in other words, when CPU 503 determines that a sufficient vacant capacity is available in buffer 300, CPU 503 detects whether or not release button 507 is pushed (step T313). When release button 507 is pushed (branch Yes of step T313), CPU 503 carries out the image capturing action shown in step T201. When release button 507 is not pushed (branch No of step T313), CPU 503 returns to step T100 and waits for an instruction for the next shooting.

### 3-2. Advantage

As discussed previously, digital camera 10 in accordance with the third embodiment sets a threshold of the stored amount in buffer 300, and switches the image capturing action as well as an image to be displayed on monitor 502 in response to the stored amount in buffer 300. This structure allows applying the brakes to the image capturing action before buffer 300 becomes full. On top of that, the brakes are not removed until a sufficient vacant capacity is found in buffer 300, so that useless switches of displaying images can be reduced.

In this third embodiment, threshold B1 of the stored amount in buffer 300 is set greater than threshold B2, however; the present disclosure is not limited to this instance. Switching conditions can be adjusted assuming that threshold B1 is smaller than threshold B2, or threshold B1 can be equal to threshold B2.

In this third embodiment, the thresholds are set with respect to the stored amount in buffer 300; however, the thresholds can be set with respect to a remaining vacant amount in buffer 300.

In this third embodiment, the imaging is done in the normally-open imaging mode regardless of the stored amount in buffer 300; however, the present disclosure is not limited to this instance. The imaging can be switched from the normally-open imaging mode to the normally-close imaging mode and vice versa as is done in the first embodiment.

### 4. Other Embodiments

Embodiments 1-3 are demonstrated hereinbefore as examples of the techniques disclosed in this patent application. However, the techniques of the present disclosure are not limited to these examples, and they are applicable to embodiments in which changes, replacements, additions, or omissions are done. Each structural element described in embodiments 1-3 can be combined to create a new embodiment. The embodiments below exemplifies these modifications.

Each of digital cameras 10 used in embodiments 1-3 is to display the BO image on the monitor during the image capturing action when the storage capacity of buffer 300 becomes full or exceeds the given amount; however, the present disclosure is not limited to this instance. In such a case, digital camera 10 can display an AV image on the monitor, or display predetermined data including a shooting condition. Digital camera 10 also can display the last frame of the LV image.

Each of digital cameras 10 used in embodiments 1-3 includes the focal-plane shutter mechanism; however, the present disclosure is not limited to this instance. Digital camera 10 can use a single-curtain shutter that is formed of an electronic front-curtain and a mechanical rear-curtain, or can use only an electronic shutter.

Each of digital cameras 10 used in embodiments 1-3 switches the shutter driving methods and the images to be displayed on the monitor; however, the present disclosure is not limited to this instance. The images to be displayed on the monitor can be switched when the continuous shooting speed needs to be lowered due to heat-up of charge motor 201 or some mechanical factors.

Embodiments 1-3 employ digital camera 10 using the interchangeable lens; however, the present disclosure is not limited to this instance. A digital camera integrating a lens, or a smart-phone can be used also.

### INDUSTRIAL APPLICABILITY

The present disclosure is applicable to imaging apparatuses capable of continuous shooting, such as digital cameras and smart-phones.

What is claimed is:

1. An imaging apparatus comprising:
an imaging unit for generating image data by imaging an object;
a recording unit for recording the image data obtained by the imaging unit;
a display unit capable of displaying a live-view image that is a real-time moving image of the image data obtained by the imaging unit and an after-view image that is a still image to be recorded in the recording unit; and
a controller for controlling the imaging unit and the display unit,
wherein the controller makes the imaging unit perform an image capturing action continuously in a first cycle, and then makes the imaging unit perform an image capturing action continuously in a second cycle longer than the first cycle, and prompts the display unit to fall in a first display state while the imaging unit performs the image capturing action in the first cycle, and prompts the display unit to fall in a second display state different from the first display state while the imaging unit performs the image capturing action in the second cycle.

2. The imaging apparatus according to claim 1, wherein the controller prompts the display unit to display the after-view image as the first display state in a linking manner to the image capturing action.

3. The imaging apparatus according to claim 1, wherein the controller provides a wait time between each one of image capturing actions while the imaging unit performs the image capturing action continuously in the second cycle, and prompts the display unit to display an image as the second display state during the image capturing action and to display a different image therefrom as the second display state during the wait time.

4. The imaging apparatus according to claim 3, wherein the controller prompts the display unit to display the live-view image as the second display state during the wait time.

5. The imaging apparatus according to claim 4, wherein the controller prompts the display unit not to display, during the image capturing action, an image shot by the imaging unit as the second display state.

6. The imaging apparatus according to claim 4, wherein the controller prompts the display section to display the after-view image as the second display state during the image capturing action.

7. The imaging apparatus according to claim 1, wherein the imaging unit further includes a shutter mechanism formed of an opening, a front curtain and a rear curtain both capable of being driven to cover the opening and to retract from the opening,
wherein the controller prompts the shutter mechanism, during a preparatory action for the image capturing action, to selectively carry out a normally-open drive that retracts the front curtain and the rear curtain from the opening and a normally-close drive that does not retract the front curtain or the rear curtain from the opening, and
wherein the controller prompts the shutter mechanism to carry out the normally-close drive while the imaging unit performs the image capturing action in the first cycle, and the controller prompts the shutter mechanism to carry out the normally-open drive while the imaging unit performs the image capturing action in the second cycle.

8. The imaging apparatus according to claim 1, wherein the recording unit is a buffer for temporarily storing the image data obtained by the imaging unit, and
wherein the controller controls whether the imaging unit is driven in the first cycle or the second cycle based on a threshold that is a first amount of a stored amount in the buffer.

9. The imaging apparatus according to claim 8, wherein while the imaging unit is driven in the second cycle in response to the stored amount in the buffer, the controller controls whether the imaging unit is driven in the first cycle or in the second cycle based on a threshold that is a second amount of the stored amount in the buffer.

10. The imaging apparatus according to claim 9, wherein the first amount is greater than the second amount.
